(19) United States
(12) Patent Application Publication
(10) Pub. No.: US 2024/0040677 A1
(43) Pub. Date: Feb. 1, 2024

(54) DOMESTIC COOKING APPLIANCE HAVING A SENSOR THAT IS LONGITUDINALLY MOVABLE BY MOTOR POWER

(71) Applicant: BSH Hausgeräte GmbH, Munich (DE)

(72) Inventors: Sebastian Sterz, Großaitingen (DE); Markus Kuchler, Gstadt am Chiemsee (DE); Matthias Vogt, Gundelfingen Donau (DE)

(21) Appl. No.: 18/268,326

(22) PCT Filed: Jan. 13, 2022
(86) PCT No.: PCT/EP2022/050621

§ 371 Date: Jun. 20, 2023

(30) Foreign Application Priority Data
Jan. 26, 2021 (DE) 102021200669.8

(51) Int. Cl. H05B 6/64

(52) U.S. Cl. CPC H05B 6/6455

(57) ABSTRACT

A household cooking appliance includes a cooking compartment wall delimiting a cooking compartment, a guide sleeve provided on the cooking compartment wall and having a cooking compartment-side end opening which opens into the cooking compartment, a sensor housed in the guide sleeve for longitudinal movement by motor power, and a closure element designed for movement by motor power together with the sensor between a closed position in which the closure element closes the end opening as the sensor is located in an end-opening-distal rest position, and an open position in which the closure element clears the end opening as the sensor is located in an end-opening-proximal measuring position.

The invention relates to a household cooking appliance comprising a cooking compartment delimited by a cooking compartment wall, wherein a sensor is provided, the sensor being longitudinally movable by motor power and being movable from a rest position located further away from the cooking compartment into a measuring position located nearer to the cooking compartment and vice versa. The invention further relates to a corresponding method. The invention can be advantageously applied, in particular, to cooking appliances having a microwave function, for example stand-alone microwave appliances or ovens having a microwave function.

WO 2015/141207 A1 discloses a heating cooker which is equipped with: an infrared sensor which is provided on the outer face of a heating chamber and which uses a plurality of infrared detection elements in order to detect the temperature of an object to be heated; and a direction setting motor which can change the direction of the infrared sensor. The heating cooker is configured such that the direction of the infrared sensor is moved into a temperature detection position when the temperature is detected and the direction of the infrared sensor is moved into a standby position when no temperature detection is carried out. As a result, it is possible to prevent a clouding of the lens of the infrared sensor and an increase in the temperature of the infrared sensor itself. Thus it is possible, for example, to maintain the infrared sensor in a state in which it is possible to detect the temperature, even immediately after steam heating has been carried out.

U.S. Pat. No. 7,696,454 B2 discloses a cooking apparatus which has an apparatus housing comprising a burner which heats an object. A first image recording facility can be provided on one side of the apparatus housing, wherein the first image recording facility can be configured so as to detect image information which corresponds to a heat source generated by the burner. A display can also be provided on one side of the apparatus housing in order to display the image information detected by the first image recording facility.

EP 0 924 964 A2 discloses a microwave oven. This microwave oven has an infrared sensor for detecting the temperature of food during the cooking process. The sensor is oriented obliquely downwardly and to the rear from the upper front edge of the cooking compartment. A closure protects the sensor when it is not required for detecting the food temperature.

DE 10 2017 220 889 A1 discloses an oven, in particular a pyrolysis oven, having an oven cavity which delimits a cooking compartment, an opening leading through the oven cavity, a sensor facility having at least one sensor element which is arranged on the side of the oven cavity facing away from the cooking compartment and which is directed through the opening into the oven cavity, and a protection facility having at least one additional sensor, wherein the protection facility is designed to identify by means of the at least one additional sensor a critical thermal state of the sensor facility and, when the critical thermal state is identified, at least one protective measure can be triggered, the protective measure being suitable for reducing a thermal stress of the at least one sensor element of the sensor facility.

DE 10 2017 220 886 A1 discloses an oven having an oven cavity which encloses a cooking compartment, an external housing, a sensor facility which is oriented into the cooking compartment and which is arranged in an interior between the oven cavity and the external housing, and at least one sensor fan for ventilating the sensor facility with cooling air, wherein the sensor facility has a tubular sensor housing which is open on the end face and in which at least one sensor element is housed, the front side thereof being oriented in the direction of the cooking compartment, the sensor facility has at least one viewing panel arranged between the sensor element and the cooking compartment, a rear end face of the sensor housing serves as an air inlet opening for cooling air, a pressure side of the sensor fan is connected to the rear end face, the sensor housing has a lateral air outlet opening for the cooling air, and a suction side of the sensor fan is connected to a space which is separate from the space of the sensor facility. The oven, in particular, is an oven which is capable of pyrolysis.

WO 2019/208527 A1 discloses a heating cooking appliance which is equipped with: a heating chamber in which an object to be heated is housed; a wall surface opening which is an opening which is provided in a wall of the heating chamber; a support frame which is provided on the outer face of the heating chamber in order to cover the wall surface opening; and a camera which is provided on the support frame so that an imaging surface is oriented through the wall surface opening toward the interior of the heating chamber. Moreover, the heating cooking apparatus is equipped with: a closure which can be opened/closed in order to block or open the imaging surface of the camera and which is provided between the wall surface opening and the camera; and a blower which blows an airflow in the direction of the camera and the closure. Moreover, the support frame has an air duct in order to suction the airflow blown out by the blower and to discharge the airflow, which has been guided to the surface, in the direction of the heating chamber through the wall surface opening.

It is the object of the present invention to remedy at least partially the drawbacks of the prior art and, in particular, to provide an economical and robust possibility of selectively exposing a sensor to a cooking compartment and to protect the sensor from being influenced by the cooking compartment.

This object is achieved according to the features of the independent claims. Preferred embodiments can be found, in particular, in the dependent claims and/or the description.

The object is achieved by a household cooking appliance comprising a cooking compartment delimited by a cooking compartment wall, wherein
a sleeve (“guide sleeve”) provided on the cooking compartment wall has a “cooking compartment-side” end opening which opens into the cooking compartment or which is oriented in the direction of the cooking compartment,
at least one sensor is housed in the guide sleeve so as to be longitudinally movable by motor power and
the cooking compartment-side end opening can be closed by means of a closure element which can be moved by motor power together with the at least one sensor, wherein
when the at least one sensor is located in a rest position further away from the cooking compartment-side end opening, the closure element closes the cooking compartment-side end opening, and
when the at least one sensor is located in a measuring position nearer to the cooking compartment-side end opening, the closure element clears the cooking compartment-side end opening for the at least one sensor.

This cooking appliance provides the advantage of a possibility, which can be implemented in a particularly robust and at the same time simple and cost-effective manner, for selectively exposing a sensor to a cooking compartment or a cooking compartment atmosphere and to protect a sensor at least thermally from the cooking compartment. The sensor and the closure element can be moved by just one common drive between the rest position and the measuring position or the closed position and the open position. The further advantage achieved by the use of the guide sleeve is that it requires only a small amount of space outside the installation space.

A further advantage is that the sensor can be moved temporarily into its measuring position without having to remain permanently in this position and to be subjected to hostile cooking compartment conditions such as high temperatures, a hostile atmosphere, etc. In this manner, in particular, it is also possible to use sensors which can carry out measurements briefly in the measuring position (active position) without being damaged but which would not permanently withstand the cooking compartment conditions prevailing therein.

The household cooking appliance can be, for example, an oven, a microwave appliance, a steam treatment appliance or any combination thereof, for example an oven with a microwave or steam treatment function. The cooking compartment wall, in particular in the case of an oven, can also be denoted as a muffle or oven cavity.

A sleeve can be understood to mean, in particular, a tubular or hollow cylindrical receiver or housing for the sensor. The sleeve is configured, in particular, in a rectilinear manner (linear longitudinal axis) but can also be curved, for example (curved longitudinal axis). The sleeve can have, for example, a circular, oval, angled or free-form cross section. In one development, the guide sleeve has a diameter of between 10 mm and 20 mm, in particular of between 11 mm and 20 mm, in particular of between 15 mm and 17 mm, quite particularly of ca. 16 mm. A sensor, for example an IR sensor, can have, for example, a typical diameter of ca. 10 mm.

In one development, the fact that the guide sleeve is provided on the cooking compartment wall can encompass that the guide sleeve is a component which is produced separately from the cooking compartment wall and which is inserted into a suitable opening of the cooking compartment wall. The guide sleeve can terminate with the cooking compartment wall, wherein in particular the cooking compartment-side end opening of the guide sleeve can terminate flush with the cooking compartment wall. The guide sleeve can alternatively protrude through the cooking compartment wall into the cooking compartment. An advantage of this embodiment is that the guide sleeve and the sensor can be coupled together separately outside the cooking compartment, in a particularly simple manner.

In one development, the fact that the guide sleeve is provided on the cooking compartment wall can encompass that it is configured as an outwardly oriented protrusion of the cooking compartment wall, i.e. it represents a region of the cooking compartment wall. An advantage of this development is that, as a result, a separate production and attachment of the guide sleeve to the cooking compartment wall can be dispensed with. An electrical connection is also implicitly provided between the guide sleeve and the cooking compartment wall, which is advantageous, in particular, for cooking appliances with a microwave function, since the region of the guide sleeve can thus be shielded from microwave radiation in a particularly simple manner.

The fact that the sensor is housed in the guide sleeve so as to be longitudinally movable by motor power encompasses, in particular, that the sensor can be moved by means of a motor along a longitudinal extent of the guide sleeve or in the longitudinal direction of the guide sleeve. The sensor can still be arranged inside the guide sleeve in its measuring position (typically close to the cooking compartment-side end opening of the guide sleeve), terminate flush with the cooking compartment-side end opening or even protrude into the cooking compartment through the cooking compartment-side end opening.

The fact that the closure element can be moved by motor power together with the sensor encompasses, in particular, that the movement of the closure element takes place together with the movement of the sensor. In one development, the closure element and the sensor can be moved by the same motor. The motor can be an electric motor, for example.

The closure element is movable, in particular, between a closed position in which it closes the cooking compartment-side end opening, in particular is positioned thereon, and an open position in which it is lifted away from the cooking compartment-side end opening of the guide sleeve. In particular, the movements of the sensor and the closure element are adapted to one another such that when the sensor is in its rest position the closure element is in its closed position, and when the sensor is in its measuring position the closure element is in its open position. The closure element can be configured, for example, in a disk-shaped manner.

The fact that the closure element “clears” the cooking compartment-side end opening “for the sensor” encompasses, in particular, that, when the end opening is cleared, the sensor is in a position or is enabled to undertake measurements of the cooking compartment and/or a cooking compartment contents. The sensor can thus also be denoted as a “cooking compartment sensor”. When the closure element is closed, when it closes the cooking compartment-side end opening, the closure element blocks the sensor and the sensor can undertake practically no meaningful measurement of the cooking compartment or cooking compartment contents.

In one development, the at least one sensor comprises at least one infrared (IR) sensor, in particular at least one IR sensor (MIR sensor) measuring in the mid-infrared range (with typical wavelengths of between, for example, 3 μm and 50 μm). The fact that the closure element “clears” the cooking compartment-side end opening “for the at least one sensor” can mean in this case that the closure element is located in a spatial region outside the field of view of the IR sensor, or occupies only a practically negligible edge region of the field of view. This can also be expressed in such a manner that the open closure element clears a view into the cooking compartment for the at least one IR sensor.

The at least one IR sensor can thus record, for example, thermal images of the cooking compartment and its contents, and in one development in various spectral ranges in the case of a plurality of IR sensors. In particular, to this end the at least one IR sensor can be an IR camera sensor which, in particular, generates thermal images constructed in a pixel-like manner. For IR sensors, the use of such an openable closure element is particularly advantageous since IR-permeable protective lenses, which can be alternatively used, are very expensive and prone to contamination.

In an alternative or additional development, the at least one sensor comprises at least one sensor (“camera sensor”) which is sensitive in the visible spectral range. The open closure element, similar to the IR sensor, clears a field of view of the at least one camera sensor for recording images from the cooking compartment.

An alternative or additional development is that the at least one sensor comprises at least one ultrasonic sensor.

An alternative or additional development is that the at least one sensor comprises at least one sensor which is designed to determine a property of the atmosphere to be measured (“atmosphere sensor”), for example an oxygen sensor, a humidity sensor, a sensor for detecting specific chemical substances, etc. In principle, such atmosphere sensors have to come into contact with the medium to be measured (the cooking compartment atmosphere) but do not use a field of view. Rather, in this case it is sufficient that the open closure element is lifted away so far from the cooking compartment-side end opening that the sensor is subjected to the cooking compartment atmosphere to a sufficient degree in practice.

In one embodiment, a further sleeve (“sensor sleeve”) is housed in the guide sleeve so as to be longitudinally movable by motor power, the at least one sensor is attached to a cooking compartment-side end face of the sensor sleeve and the sensor sleeve is connected via a mechanical connecting means, in particular a rod system, to the closure element. This embodiment provides the advantage that the sensor sleeve and thus the at least one sensor can be guided particularly easily and reliably by the guide sleeve. In particular, the guide sleeve and the sensor sleeve are longitudinally movable relative to one another. A further advantage of the sensor sleeve is that a sensor can be attached simply and securely thereto, in particular can be inserted into the cooking compartment-side end face. A further advantage is that electrical cables of the sensor can be laid easily through the sensor sleeve.

In one development, the sensor sleeve is configured as a toothed rack in which a gear wheel engages, the gear wheel being able to be driven by a motor. Thus advantageously a simple, precise and robust possibility is provided for the longitudinal movement of the sensor sleeve in the guide sleeve by motor power. To this end, an outer face of the sensor sleeve can be configured, for example, with a row of teeth.

In particular, with a configuration as a toothed rack the sensor sleeve can protrude permanently (i.e. also in the measuring position) from a rear front surface of the guide sleeve in order to ensure in a simple manner a permanent engagement of the gear wheel in the toothed rack.

In a further development, the guide sleeve has a through-hole through which the gear wheel can engage in the toothing of the sensor sleeve. As a result, the sensor sleeve can be designed to be significantly smaller than if it had to protrude in the measuring position from the side of the guide sleeve facing away from the cooking compartment. A further advantage is that the drive unit then does not need to be arranged at one end of the guide sleeve but can also be arranged in a space-saving manner adjacent to the front guide sleeve.

In yet another development, the sensor sleeve can have an external thread so that by rotating a threaded nut, which is driven by motor power and which engages in the external thread, the inner sensor sleeve can be moved in a linear manner. In the simplest case, the drive (motor) can be arranged on the end region of the guide sleeve facing away from the cooking compartment. This can be the case, for example, with a direct drive of the sensor sleeve via a hollow motor shaft (with an internal spindle thread). More complicated, but possible in principle, might be driving the sensor sleeve via a threaded nut which is rotatably mounted on the end region of the guide sleeve facing away from the cooking compartment and which in turn is driven, for example, via an external ring gear by a motor pinion.

In one embodiment, the closure element is a pivotable closure flap. As a result, it is advantageously possible in a particularly simple manner to clear a field of view for an image-forming or imaging IR sensor or camera sensor in the measuring position. A pivot axis of the closure flap can be formed, for example, with the guide sleeve or with the cooking compartment. A transmission of the movement of the sensor can be implemented in a particularly simple manner when the closure flap and the sensor sleeve are connected together via a pivotable rod. If the sensor sleeve is moved out of the rest position into the measuring position, it pushes open the closure flap via the rod. Conversely, if the sensor sleeve is moved out of the measuring position into the rest position, it pulls the closure flap out of its open position back into the closed position.

In one development, the closure element is fixedly connected to the sensor, in particular the sensor sleeve, and can be moved or is moved in a similar manner to the sensor or the sensor sleeve. This development is particularly advantageous in the case of non-image-forming or non-imaging sensors such as humidity sensors, etc. and can be implemented in a particularly simple and robust manner. In order to implement this development, the closure element can be spaced apart, for example, from the cooking compartment-side end face of the sensor sleeve via one or more rods or pins. If the sensor travels out of the rest position into its measuring position, the closure element is moved in a similar manner (in particular in a linear manner) from the cooking compartment-side discharge opening, and thus lifted away until an open position located in front of the cooking compartment-side discharge opening is reached. Conversely, when the sensor is moved back out of the measuring position into its rest position the closure element is positioned again onto the cooking compartment-side discharge opening by a corresponding (in particular linear) movement. Such a closure element can also be denoted as a closure cover. In particular, the closure element can be configured in a disk-shaped manner.

In one embodiment, the closure element at least partially consists of a poor thermally conductive material. The advantage is achieved thereby that when the sensor is located in its rest position, and the closure element thus closes the guide tube relative to the cooking compartment, it is possible to reduce the thermal stress of the interior of the guide sleeve in which the sensor is located. The closure element can consist, for example, at least partially of plastic.

In one embodiment, the household cooking appliance has a microwave function and the closure element is configured so as to be microwave-tight in its overlapping region with the cooking compartment-side end opening of the guide sleeve. Thus a leakage of microwave radiation out of the cooking compartment through the cooking compartment-side end opening into the guide sleeve is prevented. This in turn reduces the stress on the sensor and can also prevent or reduce an escape of microwave radiation out of the cooking compartment. In this case, the closure element can consist, for example, of metal.

In one development, the closure element partially consists of a poor thermally conductive material and is configured so as to be microwave-tight in its overlapping region with the cooking compartment-side end opening of the guide sleeve. Thus the advantages of shielding against heat and shielding against microwaves can be advantageously combined. For this development, the closure element can be configured, for example, to be metallic on one side—for example the side facing the cooking compartment (in the closed position)—and consist of plastic on its other side—for example the side facing the guide sleeve (in the closed position). The metallic side can be formed, for example, by a metallic coating of a main body which is made of plastic. Alternatively, the closure element can have a sandwich construction consisting of a metallic layer and a good thermally insulating, non-metallic layer.

In one embodiment, the household cooking appliance has a microwave function, the guide sleeve is configured so as to be electrically conductive on the lateral surface thereof and is electrically connected to the cooking compartment wall. As a result, a microwave tightness is advantageously achieved of the guide sleeve itself, since due to the metallic tube (guide sleeve) formed thereby, a so-called cut-off effect of a thin tube cross section is achieved and as a result no leakage of microwave radiation is discharged through the guide sleeve. This applies, in particular, if an (internal) diameter of the guide sleeve is less than 25 mm.

The guide sleeve, in particular the lateral surface thereof, can have holes or apertures in order to permit advantageously an airflow through the guide sleeve, for example in order to cool the at least one sensor. For example, a conventional built-in appliance cooling fan or a dedicated fan can be used to generate the cooling air flow. If the household cooking appliance has a microwave function, it is particularly advantageous if the holes are sufficiently small that they do not influence a resistance to microwaves.

In one embodiment, in the rest position the closure element is positioned in an airtight manner on the cooking compartment-side end opening of the guide sleeve. As a result, advantageously a particularly effective seal against steam can generally also be achieved in order to prevent an airflow out of the cooking compartment into the guide sleeve when the closure element is closed. This in turn assists a protection of the at least one sensor from thermal and chemical stress in its rest position. This embodiment can be implemented, for example, by the flap and/or the guide sleeve having a sealing ring or being provided with a sealing material in the contact region.

In one embodiment, the at least one sensor has at least one IR sensor and an inner surface of the closure element has an emissivity of approximately 1 in the IR spectral range of the sensor at least in its overlapping region with the guide sleeve. This can also be expressed in such a manner that the closure element on its side facing the interior of the guide sleeve (in the closed position) is configured as an almost ideal black radiator, the emissivity thereof being approximately 1 as a result. Thus an IR sensor at least partially views this overlapping region in its rest position. This embodiment has the advantage that the IR sensor can be calibrated when the temperature of the cooking compartment is known, since it is assumed that the temperature at the overlapping region corresponds to the temperature of the cooking compartment and the IR sensor can thus correlate or calibrate the wavelength of the IR light measured at the overlapping region with the cooking compartment temperature. The cooking compartment temperature can be detected, for example, by means of a dedicated cooking compartment temperature sensor, for example by means of a thermocouple or a different measuring probe.

The object is also achieved by a method for operating a household cooking appliance, as described above. The method can be configured in a similar manner to the household cooking appliance and vice versa and has the same advantages.

Particularly preferred is a method for operating a household cooking appliance, comprising a cooking compartment delimited by a cooking compartment wall, wherein a guide sleeve provided on the cooking compartment wall has a cooking compartment-side end opening which opens into the cooking compartment, a sensor is housed in the guide sleeve so as to be longitudinally movable by motor power, and the cooking compartment-side end opening can be closed by means of a closure element which can be moved by motor power together with the sensor, wherein in the method, by actuating a drive motor, the sensor is selectively moved out of a rest position further away from the cooking compartment-side end opening to a measuring position nearer to the cooking compartment-side end opening, and at the same time the closure element is moved out of its closed position closing the cooking compartment-side end opening into its open position clearing the cooking compartment-side end opening for the sensor, or vice versa.

In one development, during a treatment process or sequence of the household cooking appliance, such as for example a cooking sequence, the at least one sensor is moved into its measuring position in order to record measurements from the cooking compartment (images, thermal images, ultrasonic measurement, humidity measurement, etc.).

In one development, the at least one sensor is moved into its measuring position in order to record measurements from the cooking compartment and is moved back into the rest position after a measurement or measuring phase (“intermittent measurement”). This can be advantageous for protecting the at least one sensor, in particular when continuous measurement is not required.

In one development, the at least one sensor is moved into its measuring position in order to record measurements from the cooking compartment and is only moved back to its rest position when at least one predetermined criterion is fulfilled, which indicates that the sensor could be contaminated and/or damaged. For example, the at least one sensor can be moved back into its rest position when the cooking compartment temperature has reached or exceeded a specific threshold value.

In one embodiment, the sensor is an IR sensor, an inner surface of the closure element having an emissivity of approximately 1 in the spectral range of the sensor at least in its overlapping region with an interior of the guide sleeve, and a cooking compartment temperature of the cooking compartment is detected by means of a temperature probe, wherein in the method the sensor is calibrated by comparing the thermal radiation detected on the inner surface of the closure element and the cooking compartment temperature detected by means of the temperature probe.

In practice, for example in a cooking appliance, the typically uniform temperature distribution in the cooking compartment of the switched-off cooking appliance can be utilized in order to calibrate the IR sensor, since in this state the cooking compartment temperature measured by the temperature probe of the cooking appliance correlates very well with the temperature of adjacent components and thus the temperature of the closure element. In addition or alternatively, a calibration at higher temperatures is also possible, in particular if it is known, for example via an allocation table, how the cooking compartment temperature and the temperature of the closure element relate to one another.

The above-described properties, features and advantages of this invention and the manner in which they are achieved become clearer and more readily understood in connection with the following schematic description of an exemplary embodiment which is explained in more detail in combination with the drawings.

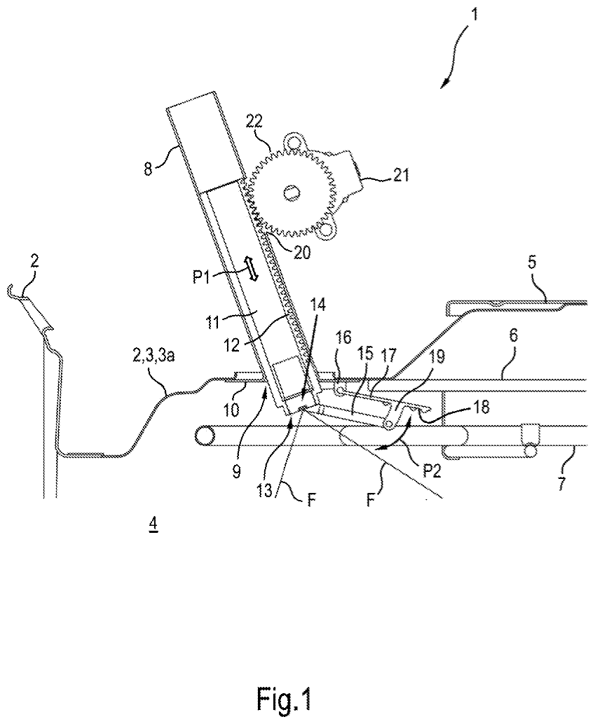

FIG. 1 shows, as a sectional drawing in side view, components of a household cooking appliance with the sensor in its measuring position; and

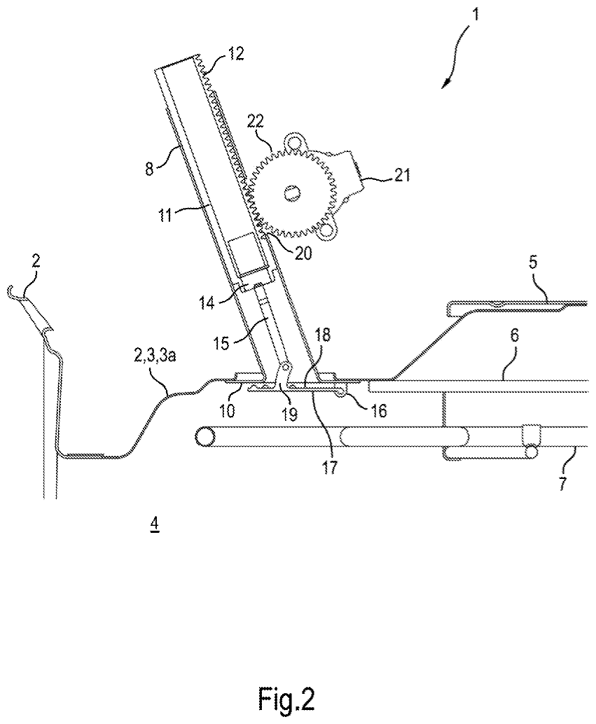

FIG. 2 shows, as a sectional drawing in side view, the components of the household cooking appliance of FIG. 1 with the sensor in its rest position.

FIG. 1 shows, as a sectional drawing in side view, components of a household cooking appliance 1 in the form of a combined oven/microwave oven. In particular, a muffle 2 which also serves as cooking compartment wall 3 of a cooking compartment 4 is illustrated. A dome 5 for receiving a rotating antenna (not shown) is illustrated in a ceiling 3a of the cooking compartment wall 3, in particular centrally, microwaves being able to be supplied thereby into the cooking compartment 4. The dome 5 is separated from the actual cooking compartment 4 by a cover 6 which is permeable to microwaves. In the cooking compartment 4 there is also at least one heating element 7 for heating the cooking compartment 4 and/or for irradiating food to be cooked with heat radiation, in this case a tubular top heat and/or grill resistance heating element which is arranged on the ceiling side.

A guide sleeve 8 in the form of a rectilinear, circular cylindrical tube is arranged on the ceiling 3a. This guide sleeve has an edge 10 which is bent over in the manner of a flange on its cooking compartment-side end opening 9 which opens into the cooking compartment 4. The guide sleeve 8 in this case is a separately produced component which has been passed from the cooking compartment 4 through a through-hole or hole in the ceiling 3a such that the edge 10 bears on the inner face against the ceiling 3a and has been fastened thereto in an airtight manner, for example by laser welding. In the present case, the edge 10 is configured obliquely to a longitudinal axis of the guide sleeve 8 so that the mounted guide sleeve 8 is located obliquely. This improves the view into the cooking compartment 4 when the guide sleeve 8 is arranged eccentrically.

If the guide sleeve 8 consists of metal, it is electrically connected to the cooking compartment wall 8 which is also metallic. The diameter of the guide sleeve 8 in this case is ca. 16 mm and, as a result, in a metallic or metal-coated embodiment is impermeable to microwaves at frequency ranges typical for household microwave appliances of around 915 MHz or 2.45 GHz. The guide sleeve 8 can have small holes or apertures which, in particular, do not influence a resistance to microwaves. As a result, an improved cooling of the at least one sensor 14 can be achieved, since the cooling airflow of a conventionally installed appliance cooling fan (not shown) can be used in this manner in order to generate an airflow through the guide sleeve 8.

A sensor sleeve 11 is housed in the guide sleeve 8 so as to be longitudinally movable by motor power. This is achieved by an outer face of the sensor sleeve 11 being configured with a row of teeth 12 extending in the longitudinal direction and the guide sleeve 8 having in its lateral surface or side wall an aperture 20 through which the row of teeth 12 is exposed. The household cooking appliance 1 also has an electric motor 21, a gear wheel 22 being positioned on the drive shaft thereof and the ring gear thereof in turn engaging through the aperture 20 in the row of teeth 12. By actuating the electric motor 21 and by a corresponding rotation of the gear wheel 22, the sensor sleeve 11, as indicated by the double arrow P1, can move between two end positions, and namely between the measuring position shown and a rest position explained in more detail below and shown in FIG. 2.

A sensor, in this case an IR sensor 14, which in the variant shown terminates flush with the cooking compartment-side end face 13 is incorporated on the cooking compartment-side end face 13 of the sensor sleeve 11. Thus the IR sensor 14 is also housed in the guide sleeve 8 so as to be longitudinally movable by motor power. Outside the rest position, the IR sensor can be moved or is moved out of the guide sleeve 8—as shown for the measuring position. The IR sensor can have, for example, a diameter of ca. 10 mm which thus also corresponds to the internal diameter of the tubular sensor sleeve 11.

A rod 15 is rotatably connected to the sensor sleeve 11, the rod protruding relative to the sensor sleeve 11 on the cooking compartment side. On the other side, the rod 15 is connected to a closure flap 17 which is pivotably attached to the edge 10 via a hinge 16, resulting in a possibility of movement of the closure flap 17 as indicated by the double arrow P2. More specifically, the other end region of the rod 15 is rotatably connected to a projection 19 protruding vertically in an overlapping region 18 of the closure flap 17.

In the measuring position of the IR sensor 14 shown, the closure flap 17 is pivoted by the rod 15 sufficiently far away from the end face 13 of the sensor sleeve 11 that the cooking compartment-side end opening is cleared for the IR sensor and the closure flap 17 is no longer located in the field of view F of the IR sensor 14. The IR sensor 14 can thus record a thermal image of the cooking compartment 4 uninterrupted by the closure flap 17.

If the sensor sleeve 11 is retracted out of the measuring position into the guide sleeve 8, the IR sensor 14 is also retracted into the guide sleeve 8 until reaching a rest position which is further away from the cooking compartment 4. The IR sensor 14 and the closure flap 17 thus can be moved together by the electric motor by motor power.

Generally the sensor sleeve 11 can be moved between the operating position and the rest position. In one development, the sensor sleeve 11 can also be moved in a targeted manner to intermediate positions.

If the sensor sleeve 11 is retracted into the guide sleeve 8, it pulls the rod 15 therewith into the guide sleeve 8, whereby the closure flap 17 is pivoted about the hinge 16 in the direction of the cooking compartment-side end opening 9. This closing movement can be continued until the IR sensor 14 is located in its rest position, in which case the closure flap 17 is in its closed position in which it covers the cooking compartment-side end opening 9. The covering region 18 thus faces into the guide sleeve 8. The projection 19 is also housed in the guide sleeve 8.

The closure flap 17 or the edge 10 can be configured so as to be sealed, for example by providing a sealing ring (not shown) or a sealed coating. Thus in the rest position an entry of air into the guide sleeve 8 can be particularly reliably avoided.

The closure flap 17 can be configured, in particular, in a disk-shaped manner and, for example, can be configured (for example covered or coated) to be metallic on its side (“outer face”) facing into the cooking compartment 4 in the rest position, and on its inner face which faces into the guide sleeve 8 in the rest position and which corresponds to the covering region 18, it can consist of a poor thermally conductive material, for example of plastic, ceramic, micanite, or the like. An entry of microwaves into the guide sleeve 8 can also be particularly effectively prevented by the metallic layer.

In particular, the covering region 18 can have a surface with an emissivity of approximately 1. In this case, the covering region 18, which is located in the rest position of the IR sensor 14 in the field of view thereof, can be used to calibrate the IR sensor 14 in its rest position.

In a cooking sequence, the household cooking appliance 1 can be operated, for example, as follows;

In a variant, thermal images from the cooking compartment 4, and thus also of food to be cooked which is located in the cooking compartment 4, can be recorded practically continuously or at short time intervals. To this end, the electric motor is actuated at the start of the cooking sequence, such that the sensor sleeve 11 is moved forward out of the retracted rest position in the direction of the cooking compartment 4, and via the rod 15 which pushes open the closure flap 17, which was previously located in its closed position, so that this closure flap lifts away from the cooking compartment-side end opening 9. The sensor sleeve 11 is moved sufficiently far until the measuring position shown in FIG. 1 is reached. In the measuring position, the thermal images are recorded by the IR sensor 14. The sensor sleeve 11 is retracted in the reverse direction into the guide sleeve 8, in particular if (a) the IR sensor 14 is no longer required, for example because the cooking sequence is terminated and/or (b) the IR sensor 14 could be damaged, for example because the cooking compartment temperature has reached or exceeded a predetermined threshold value. In the rest position, the IR sensor 14 is protected relative to the cooking compartment 4 by the closure flap 17 and namely relative to microwaves, thermal radiation and a cooking compartment atmosphere. Additionally, in the rest position the IR sensor 14 is moved relatively far away from the cooking compartment 4 so that the thermal stress thereof is also reduced thereby.

In a further variant, thermal images are recorded at longer time intervals. To this end, the IR sensor 14 only needs to be moved out of the rest position into its measuring position for one respective recording, and is moved back again into its rest position after the recording.

Naturally the present invention is not limited to the exemplary embodiment shown.

Generally “one”, etc. can be understood to mean a singular or a plurality thereof, in particular in the sense of “at least one” or “one or more”, etc. provided this is not explicitly excluded, for example, by the expression “exactly one”, etc.

A numerical specification can also encompass exactly the specified number and a usual tolerance range, provided this is not explicitly excluded.

### LIST OF REFERENCE CHARACTERS

1 Household cooking appliance
2 Muffle
3 Cooking compartment wall
3a Ceiling
4 Cooking compartment
5 Dome
6 Cover
7 Heating element
8 Guide sleeve
9 Cooking compartment-side end opening
10 Edge
11 Sensor sleeve
12 Toothed rack
13 End face
14 IR sensor
15 Rod
16 Hinge
17 Closure flap
18 Overlapping region
19 Projection
20 Aperture in guide sleeve
21 Electric motor
22 Gear wheel
P1 Double arrow
P2 Double arrow

1-10. (canceled)

11. A household cooking appliance, comprising:
a cooking compartment wall delimiting a cooking compartment;
a guide sleeve provided on the cooking compartment wall and having a cooking compartment-side end opening which opens into the cooking compartment;
a sensor housed in the guide sleeve for longitudinal movement by motor power; and
a closure element designed for movement by motor power together with the sensor between a closed position in which the closure element closes the cooking compartment-side end opening when the sensor is located in an end-opening-distal rest position, and an open position in which the closure element clears the cooking compartment-side end opening for the sensor when the sensor is located in an end-opening-proximal measuring position.

12. The household cooking appliance of claim 11, further comprising a sensor sleeve housed in the guide sleeve for longitudinal movement by motor power, and a rod system designed to connect the sensor sleeve to the closure element, said sensor being attached to a cooking compartment-side end face of the sensor sleeve.

13. The household cooking appliance of claim 11, wherein the closure element is a pivotable closure flap.

14. The household cooking appliance of claim 11, wherein the closure element is made of a poor thermally conductive material.

15. The household cooking appliance of claim 11, further comprising a microwave function, said closure element designed to be microwave-tight in an overlapping region with the cooking compartment-side end opening of the guide sleeve.

16. The household cooking appliance of claim 11, further comprising a microwave function, said guide sleeve being designed to be electrically conductive on a lateral surface thereof and electrically connected to the cooking compartment wall.

17. The household cooking appliance of claim 11, wherein in the rest position the closure element is positioned in an airtight manner on the cooking compartment-side end opening of the guide sleeve.

18. The household cooking appliance of claim 11, wherein the sensor is an IR sensor, said closure element having an inner surface with an emissivity of approximately 1 in an IR spectral range of the sensor at least in an overlapping region of the closure element.

19. A method for operating a household cooking appliance which comprises a cooking compartment delimited by a cooking compartment wall, a guide sleeve with a cooking compartment-side end opening, a sensor housed in the guide sleeve, and a closure element, said method comprising:
moving the sensor through selective actuation of a drive motor between a rest position in which the sensor is located distal to the cooking compartment-side end opening and the closure element assumes a closed position in which the cooking compartment-side end opening is closed, and a measuring position in which the sensor is located proximal to the cooking compartment-side end opening and the closure element assumes an open position in which the cooking compartment-side end opening is cleared.

20. The method of claim 29, wherein the sensor is an IR sensor, and the closure element has an inner surface with an emissivity of approximately 1 in an IR spectral range of the sensor at least in an overlapping region of the closure element, and further comprising:
detecting with a temperature probe a cooking compartment temperature of the cooking compartment; and
calibrating the sensor by comparing a thermal radiation detected on the inner surface of the closure element and the cooking compartment temperature detected by the temperature probe.
